(19) United States
(12) Patent Application Publication
(10) Pub. No.: US 2006/0267879 A1
(43) Pub. Date: Nov. 30, 2006

(54) ELECTRON EMISSION DISPLAY AND DRIVING METHOD THEREOF

(75) Inventor: Chul Ho Lee, Chenoan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD., Suwon-si (KR)

(21) Appl. No.: 11/383,875

(22) Filed: May 17, 2006

(30) Foreign Application Priority Data
May 31, 2005 (KR) 10-2005-0046442

(51) Int. Cl. G09G 3/22

(52) U.S. Cl. 345/75.2

(57) ABSTRACT

A scan driver or a power supply in an electron emission display may be controlled to protect the electron emission display when a pulse of a scan signal pauses in an on signal state for a predetermined period.

### CROSS REFERENCE TO RELATED APPLICATIONS

This application claims priority to and the benefit of Korean Patent Application No. 2005-46442, filed on May 31, 2005, which is hereby incorporated by reference for all purposes as if fully set forth herein.

### BACKGROUND OF THE INVENTION

1. Field of the Invention

The present invention relates to an electron emission display and a driving method thereof, and more particularly, to an electron emission display and a driving method thereof, which protects a panel when a scan signal is paused.

2. Discussion of the Background

Thin and lightweight flat panel displays have been widely used as display units for personal computers, portable computers, personal digital assistants (PDAs), and the like, and as monitors for various information devices. Flat panel displays include liquid crystal displays (LCDs), which use liquid crystal, organic light emitting displays (OLEDs), which use an organic light emitting diode, and plasma display panels (PDPs), which use plasma.

Flat panel displays may be classified as active matrix types or passive matrix types according to the display structure. Flat panel displays may also be classified as memory driving types or non-memory types according to the emission principle used. Active matrix type displays are memory driving type displays, and passive matrix type displays are non-memory driving type displays. In other words, active matrix type displays and memory driving type displays emit light per unit of a frame, and passive matrix type displays and non-memory driving type displays emit light per unit of a line.

Among large flat panel displays that are currently commercialized, thin film transistor liquid crystal displays (TFT-LCD) and OLEDs may be active matrix type displays. Electron emission displays may be passive matrix and non-memory driving type displays, which use a line scan method, in which horizontal lines are selected in sequence and only the selected line emits light. An electron emission display is driven with a constant duty ratio.

FIG. 1 illustrates the structure of a conventional electron emission display. Referring to FIG. 1, the conventional electron emission display may include a pixel portion 10, a data driver 20, a scan driver 30, a controller 40, and a power supply 50.

The pixel portion 10 may includes a plurality of pixels 11 formed where cathode electrodes C1, C2, . . . , Cn intersect gate electrodes G1, G2, . . . , Gn. The plurality of pixels 11 may emit light when electrons emitted from a cathode electrode collide with fluorescent material of an anode electrode, thereby representing a gray level. The gray level of a displayed image may be varied according to the values of a digital video signal. A pulse width modulation (PWM) method and a pulse amplitude modulation (PAM) method may be employed to control the gray level represented by the value of the digital video signal.

The data driver 20 may be coupled to the cathode electrodes C1, C2, . . . , Cn and may output a data signal to the pixel portion 10 to drive the pixel portion 10 to emit light.

The scan driver 30 may be coupled to the gate electrode G1, G2, . . . , Gn and may output a scan signal to the pixel portion 10 to control the pixel portion 10 by the line scan method and cause the pixel portion 10 to display an image by emitting light per unit of a horizontal line for a predetermined period. The line scan method may reduce circuit cost and power consumption.

The timing controller 40 may transmit a data control signal and a scan control signal to the data driver 20 and the scan driver 30, respectively, to control the data driver 20 and the scan driver 30.

The power supply 50 may supply power to the pixel portion 10, the data driver 20, the scan driver 30, and the timing controller 40 to enable them to operate.

An electron emission display with this configuration may employ the line scan method. In the line scan method, a current approximating a direct current (DC) may flow in a certain line when the circuit is abnormal due to an external impulse, noise, or the like and may pause the line selecting operation. When the DC flows in a certain line, the panel and the circuit may be damaged, and the circuit may generate heat. For example, if the scanning operation is paused while the horizontal lines are sequentially selected to emit light with a constant duty ratio, a pulse approximating the DC may be applied to a certain line instead of a pulse having a constant duty, so that an emission current is generated only in the certain line. In this case, the cathode electrode of the panel may be damaged.

Additionally, a current higher than a rated current may flow in the scan line corresponding to the paused scanning operation, which may cause a driving circuit to generate heat and become damaged.

### SUMMARY OF THE INVENTION

This invention provides an electron emission display and a driving method thereof, in which a scan driver or a power supply is controlled to protect the electron emission display when a pulse of a scan signal pauses for a predetermined period of time.

Additional features of the invention will be set forth in the description which follows, and in part will be apparent from the description, or may be learned by practice of the invention.

The present invention discloses an electron emission display includes a pixel portion to display a picture based on a data signal and a scan signal; a data driver to output the data signal to the pixel portion; a scan driver to output the scan signal to the pixel portion; a timing controller to output a driving signal to drive the data driver and the scan driver; a scan signal sensor to control the operation of the scan driver on the basis of the scan signal output from the scan driver; and a power supply to supply driving power to the pixel portion, the data driver, the scan driver, the timing controller, and the scan signal sensor.

The present invention also discloses a method of driving an electron emission display that includes generating a control signal corresponding to a scan signal; and controlling the operation of a scan driver on the basis of the control signal.

The present invention also discloses a method of driving an electron emission display that includes generating a control signal corresponding to a scan signal; and controlling the operation of a power supply on the basis of the control signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates the structure of a conventional electron emission display.

FIG. 2 illustrates the structure of an electron emission display according to an exemplary embodiment of the present invention.

FIG. 3 is a perspective view of a pixel portion in the electron emission display according to an exemplary embodiment of the present invention.

FIG. 4 is a sectional view of the pixel portion in the electron emission display according to an exemplary embodiment of the present invention.

FIG. 5 is a timing diagram of input/output waveforms in a scan driver according to an exemplary embodiment of the present invention.

FIG. 6 illustrates an exemplary structure of a logic integrated circuit (IC) used in a scan signal sensor according to an exemplary embodiment of the present invention.

FIG. 7 is a timing diagram of input/output waveforms in the logic IC shown in FIG. 6.

FIG. 8A and FIG. 8B are timing diagrams of input/output waveforms in the scan signal sensor according to an exemplary embodiment of the present invention.

FIG. 9 illustrates a connection among a timing controller, the scan signal, and the scan driver according to an exemplary embodiment of the present invention.

FIG. 10 is a timing diagram showing an operation of the scan signal sensor according to an exemplary embodiment of the present invention.

FIG. 11 illustrates a connection among a timing controller, the scan signal, and the scan driver according to an exemplary embodiment of the present invention.

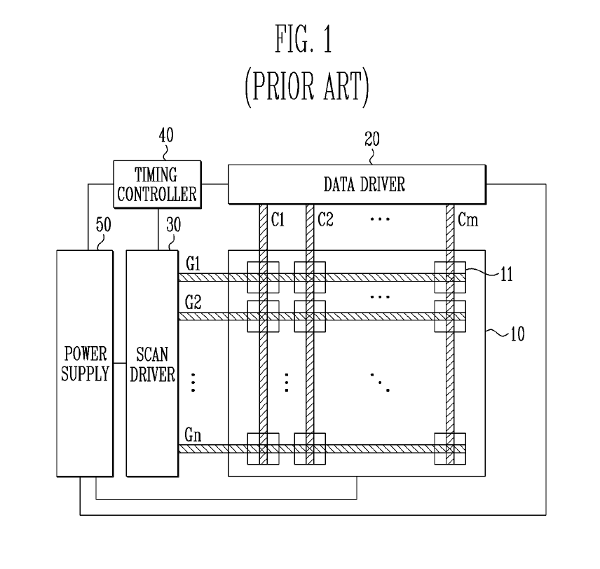

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

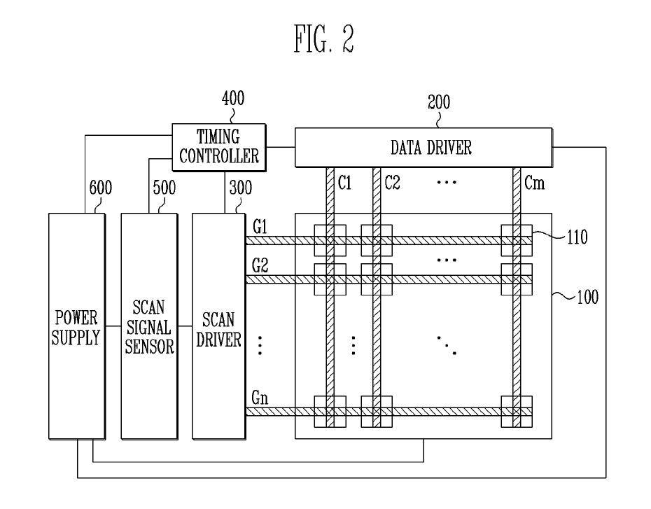

FIG. 2 illustrates the structure of an electron emission display according to an exemplary embodiment of the present invention. Referring to FIG. 2, an electron emission display may include a pixel portion 100, a data driver 200, a scan driver 300, a timing controller 400, a scan signal sensor 500, and a power supply 600.

The pixel portion 100 may include a plurality of cathode electrodes C1, C2, . . . , Cn arranged in a vertical direction, a plurality of gate electrodes G1, G2, . . . , Gn arranged in a horizontal direction, and a plurality of emitters (not shown) formed where the cathode electrodes C1, C2, . . . , Cn intersect the gate electrodes G1, G2, . . . , Gn, thereby forming a plurality of pixels 110. Alternatively, the gate electrodes may be arranged in the vertical direction, and the cathode electrode may be arranged in the horizontal direction. FIG. 2 illustrates a pixel portion 110 in which the cathode electrodes C1, C2, . . . , Cn are arranged in the vertical direction, and the gate electrodes G1, G2, . . . , Gn are arranged in the horizontal direction.

The data driver 200 may be coupled to the cathode electrodes C1, C2, . . . , Cn and may output a data signal to the cathode electrodes C1, C2, . . . , Cn. The data driver 200 may generate an electrode signal to turn the pixel formed where the cathode electrodes C1, C2, . . . , Cn intersect the gate electrodes G1, G2, . . . , Gn on and off.

The scan driver 300 may be coupled to the gate electrodes G1, G2, . . . , Gn, and may select one of the horizontal gate electrodes G1, G2, . . . , Gn, thereby allowing the data signal to be transmitted to the pixel coupled to the selected gate electrode.

The timing controller 400 may receive a video signal and may generate and output control signals to the data driver 200 and the scan driver 300. The timing controller 400 may generate the control signal for driving the data driver 200, and the control signal for controlling the scan driver 300 to select the horizontal lines in sequence.

The scan signal sensor 500 may sense the scan signal output from the scan driver 300, and may stop the scan driver 300 or the power supply 600 from operating when a pulse of the scan signal pauses on for a predetermined period. This may protect the electron emission display by preventing the electron emission display from displaying an image for too long a time. The scan signal sensor 500 may include a logic IC, and may compare the scan signal with a predetermined signal to control the operations of the scan driver 300 and the power supply 600.

The power supply 600 may supply power needed for the respective components. For example, the power supply 600 may supply anode voltage to the pixel portion 100, and driving voltages to the data driver 200, the scan driver 300, the timing controller 400 and the scan signal sensor 500.

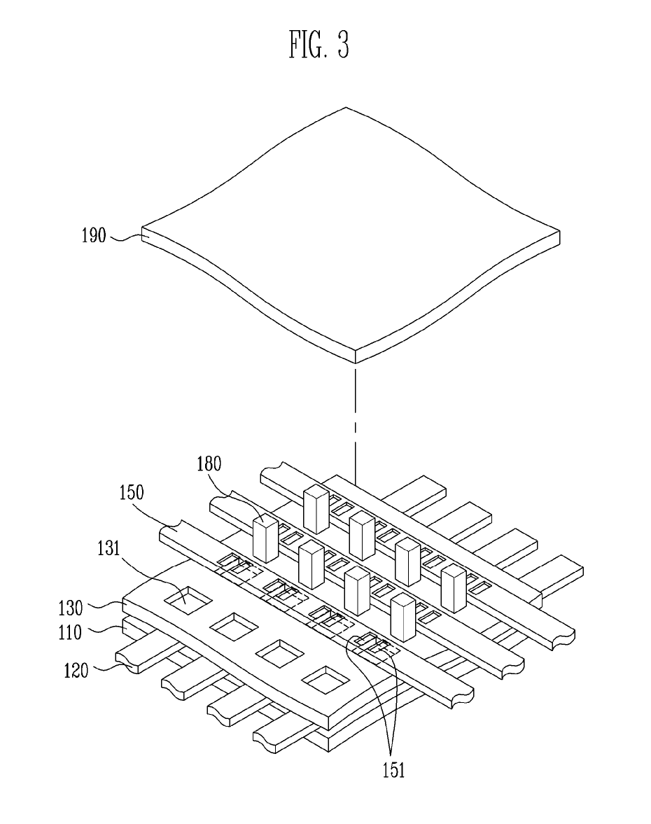

FIG. 3 is a perspective view of a pixel portion in the electron emission display according to an exemplary embodiment of the present invention. FIG. 4 is a sectional view of the pixel portion in the electron emission display according to an exemplary embodiment of the present invention.

Referring to FIG. 3 and FIG. 4, an electron emission display may include a bottom substrate 110, a top substrate 190, and a spacer 180. The bottom substrate 110 may have a cathode electrode 120, an insulating layer 130, an emitter 140, and a gate electrode 150 arranged on it. The top substrate 190 may include a front substrate, an anode electrode and a fluorescent film arranged on it.

At least one stripe-shaped cathode electrode 120 may be formed on the bottom substrate 110. The insulating layer 130 may be formed on the cathode electrode 120. The insulating layer 130 may include a plurality of first holes 131 through which the cathode electrode 120 may be partially exposed. The gate electrode 150 may be formed on the insulating layer 130. The gate electrode 150 may include a plurality of second holes 151 that correspond to the first holes 131. The emitter 140 may be formed in a region of the cathode electrode 120, in which the first hole 131 is aligned with the second hole 151.

The bottom substrate 110 may be made of glass or silicon. A transparent substrate, such as a glass substrate, may be employed as the bottom substrate 110 if the emitter 140 is formed by applying a rear-side exposure to a paste.

The cathode electrode 120 may supply the data signal from the data driver (not shown) or the scan signal from the scan driver (not shown) to the emitter 140. The cathode electrode 120 may be made of indium tin oxide ITO.

The insulating layer 130 may be formed on the bottom substrate 110 and the cathode electrode 120 to electrically insulate the cathode electrode 120 from the gate electrode 150.

The gate electrode 150 may be formed on the insulating layer 130. The gate electrode 150 may have a predetermined shape, such as a stripe shape, that is arranged to intersect the cathode electrode 120. The gate electrode 150 may supply the data signal from the data driver or the scan signal from the scan driver to each pixel. The gate electrode 150 may be made of a conductive metal, such as gold (Au), silver (Ag), platinum (Pt), aluminum (Al), chrome (Cr) and alloys thereof.

The emitter 140 may be formed on the portion of the cathode electrode 120 that is exposed through the first hole 131 of the insulating layer 130. The emitter 140 may be electrically coupled to the cathode electrode 120. The emitter 140 may be made of various materials that can emit electrons when an electric field is applied thereto, such as carbonaceous material or nano-sized material, such as carbon nanotube (CNT), graphite, graphite nanofiber, diamond-like-carbon, C₆₀, silicon nanowire, or a combination thereof

The top substrate 190 may include an anode electrode and a fluorescent film. The electric field applied to the anode electrode may cause electrons to be emitted from the emitter 140 and collide with the fluorescent film, thereby emitting light.

The spacer 180 may be interposed between the bottom substrate 110 and the top substrate 190, and may maintain a uniform distance between the bottom substrate 110 and the top substrate 190.

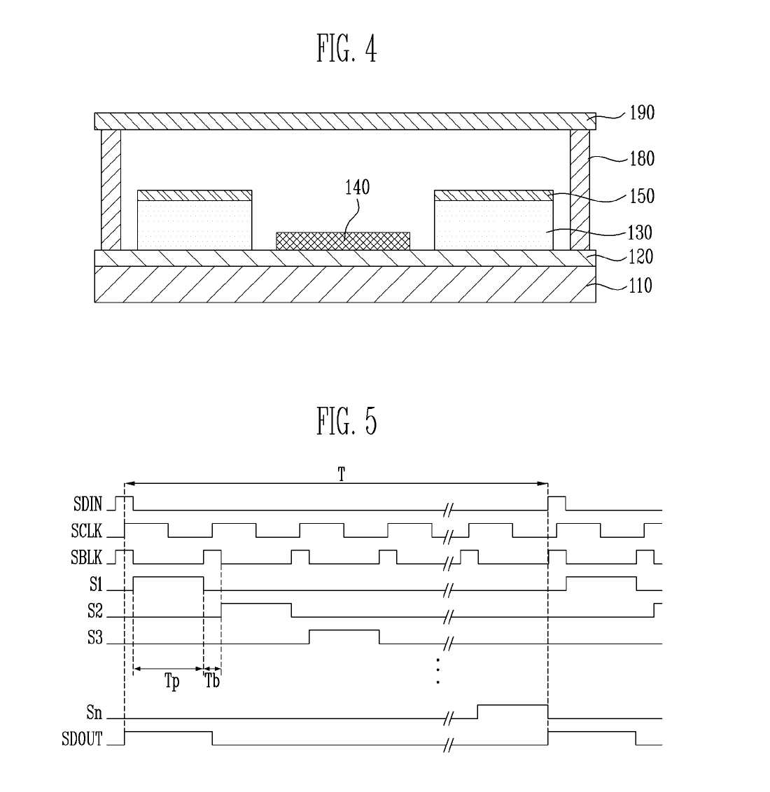

FIG. 5 is a timing diagram of input and output waveforms in a scan driver according to an exemplary embodiment of the present invention. In FIG. 5, “T” indicates a period of the scan signal, “Tp” indicates the maximum time of when one line emits light for one period, “Tb” indicates a blank time between the lines. The duty ratio is calculated as “Tp/T”. A frequency of a video frame may be, for example, 60 Hz.

In a line scan method, a signal SDIN may be input as an on-signal to scan the line once a frame. The pulse of the SDIN signal may have a period of 16.7 ms. Further, a signal SCLK may be input as a clock signal for a shift register provided in the scan driver, and may shift the scan line. A signal SBLK may be input as a blanking signal given between the lines, and may be used for preventing two lines from being selected at the same time due to the rising or falling delay in output waveforms of the scan driver. When the signal SBLK is high, all output is in an off state. A signal SDOUT may be finally outputted by passing the signal SDIN through the shift register. The signal SDOUT may be a serial data output signal that has the same period as the signal SDIN.

The signal SDIN may be input to the shift register, and shifted by the signal SCLK to be output as the signal SDOUT. Therefore, the SDIN signal may have the same period as the signal SDIN and the same pulse width as the signal SCLK.

In a normal state, pulses are output like the signal SDOUT every 16.7 ms. If the scan operation is stopped, pulses are not output like the signal SDOUT and the pulses are maintained as a high signal or a low signal.

The brightness of the electron emission display may be proportional to the amount of electrons emitted, and the amount of electrons emitted is proportional to the duty ratio. Therefore, the brightness, the emission current, and the duty ratio are proportional to each other. When a scan signal having a predetermined waveform is continuously applied to a certain scan line, the duty ratio increases as much as the number of horizontal lines, and excessive emission current is generated, which causes the corresponding line to emit light that is brighter than that of other lines. This may reduce the durability of the emitter and may damage the circuit and the pixel portion.

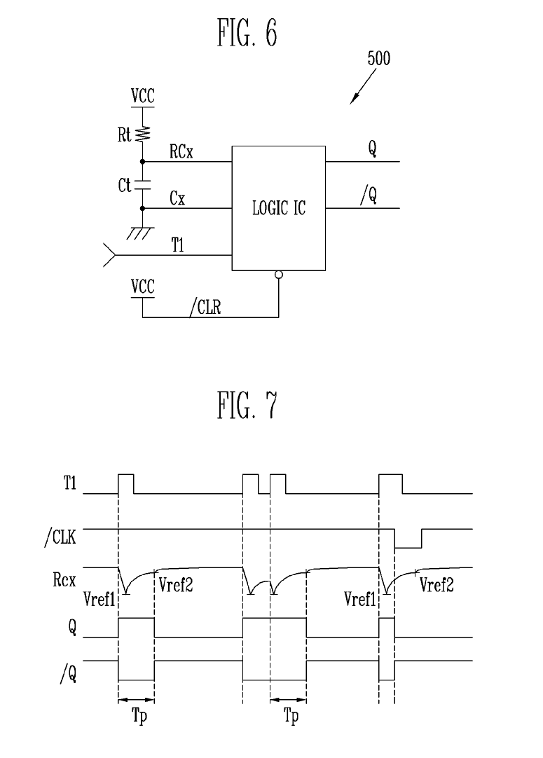

FIG. 6 illustrates an exemplary structure of a logic integrated circuit (IC) used in a scan signal sensor according to an exemplary embodiment of the present invention. FIG. 7 is a timing diagram of input/output waveforms in the logic IC shown in FIG. 6. Referring to FIG. 6 and FIG. 7, a scan signal sensor 500 may sense whether the output waveform of the scan driver 300 is periodical or not, and may determine that the scan operation is stopped when there is no pulse waveform within a predetermined time. The scan signal sensor 500 may be achieved by a monostable multivibrator.

The logic IC may include a terminal RCx, a terminal Cx, a terminal T1, a terminal /CLR, a terminal Q and a terminal /Q. The terminal RCx and the terminal Cx may be employed to couple an external resistor and a capacitor used as variance to determine the pulse width. The terminal T1 may be a trigger input terminal to output the pulse, and the terminal /CLR may be a terminal to reset the output. The terminal Q and the terminal /Q may be used as output terminals to output the pulse.

To generate the pulse, a signal varying from the low level to the high level may be input to the T1 terminal while the high signal is input through the /CLR terminal. The pulse may then be output from the output terminals Q and /Q according to the resistance of the resistor Rt coupled to the terminal RCx and the capacitance of the capacitor Ct coupled to the Cx terminal.

When a signal is input through the terminal T1, the pulse may be generated and output through the output terminal when the signal is varied from the low level to the high level. The width Tp of the pulse may be determined depending on the resistor Rt and the capacitor Ct coupled to the outside of the logic IC. In general, a monostable multivibrator logic IC has a characteristic of “Tp=k×Rt×Ct”, where k is a constant varying according to the logic IC (generally, 0<k<1)

For example, in the case of a 74HC/HCT4538 Philips semiconductor, “Tp=0.7Rt×Ct”, where Tp is measured in ns, Rt is measured in kΩ, and Ct is measured in pF. In the case of a DM74LS123 Fairchild semiconductor, “Tp=0.37Rt×Ct”, where Tp is measured in ns, Rt is measured in kΩ, and Ct is measured in pF.

A first pulse generated through the output terminal Q is continuously maintained for a time Tp from the time when another pulse is input through the terminal T1. Further, when a reset signal is input through the terminal /CLR, the logic IC resets the output regardless of the input.

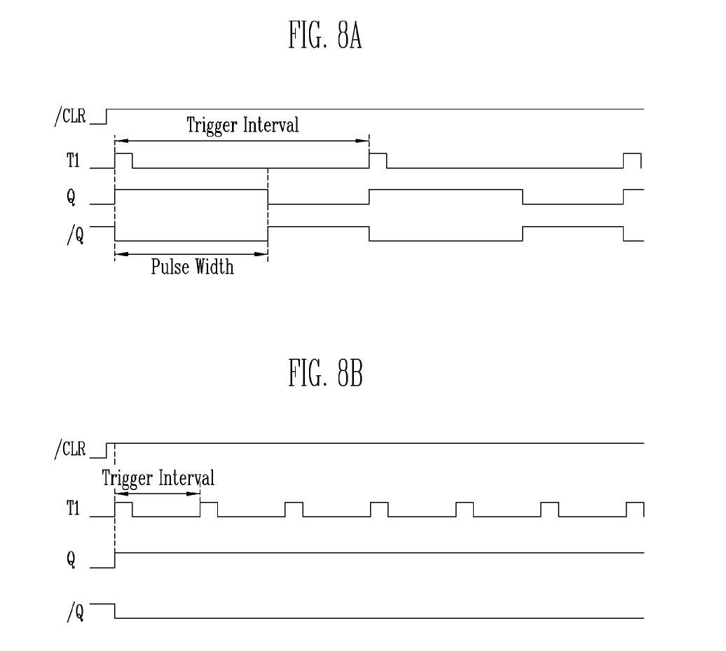

FIG. 8A and FIG. 8B are timing diagrams of input/output waveforms in the scan signal sensor according to an exemplary embodiment of the present invention. Referring to FIG. 8A and FIG. 8B, when a trigger signal is input, the output terminal outputs a pulse having a constant width of about “k×Rt×Ct”.

FIG. 8A shows an example in which an input trigger interval of the terminal T1 is larger than the output pulse width. The pulse is generated and maintained with a reference level, and then another pulse is generated when the next trigger signal is input.

FIG. 8B shows an example in which an input trigger interval of the terminal T1 is smaller than the output pulse width. When the trigger signal is input, the output level is changed and the pulse width is maintained for a predetermined period. However, when the trigger signal is input again before the trigger interval is out, the corresponding output level is maintained again for the predetermined time from the time when the trigger signal is input. Therefore, when the trigger signal is input at intervals shorter than the pulse width, the output level for generating the pulse is maintained.

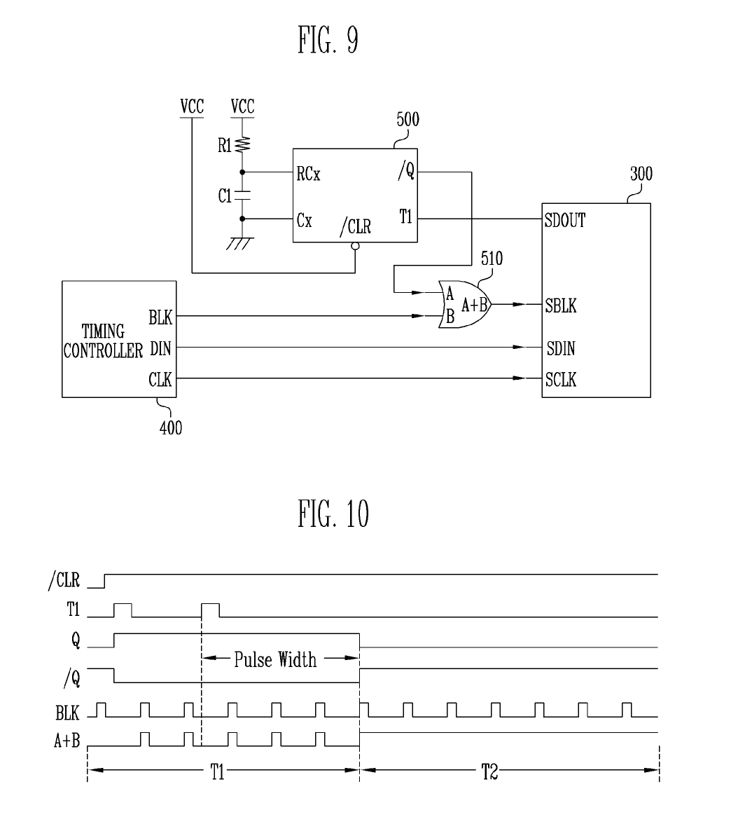

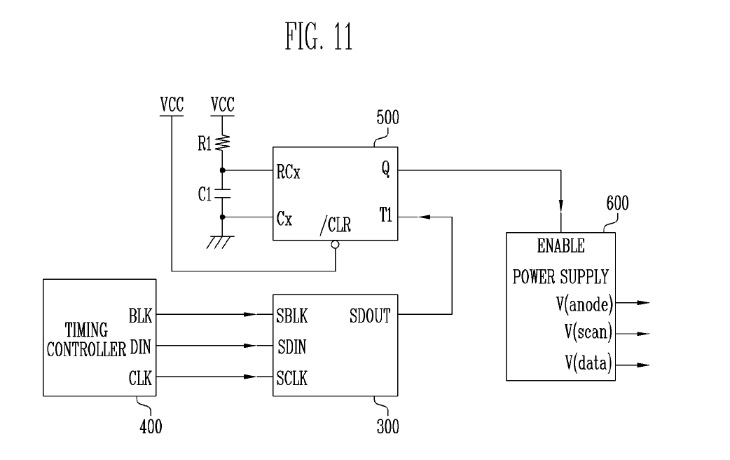

FIG. 9 illustrates the connections among a timing controller 400, the scan signal sensor 500, and the scan driver 300 according to an exemplary embodiment of the present invention. FIG. 10 is a timing diagram showing an operation of the scan signal sensor according to an exemplary embodiment of the present invention. Referring to FIG. 9 and FIG. 10, the scan signal sensor 500, which is a logic IC , has a terminal T1 coupled to a terminal SDOUT of a scan driver 300, and a terminal /Q coupled to one input terminal of an OR gate 510. A timing controller 400 has a blanking signal output terminal BLK coupled to the other input terminal of the OR gate 510. The OR gate 510 outputs an operation signal to a blanking signal input terminal SBLK of the scan driver 300.

When the scan operation is normal, the output /Q of the logic IC has a low level, so that the timing controller 400 outputs a signal BLK to the blanking signal input terminal SBLK of the scan driver 300. On the other hand, when the scan operation is paused, the output /Q of the logic IC has a high level, so that the OR gate 510 outputs the high level to the blanking signal input terminal SBLK of the scan driver 300 regardless of the output signal BLK of the timing controller 400, thereby allowing the scan driver 300 to output the blanking signal.

In this exemplary embodiment, the circuit configuration may vary according to the structure of the pixel portion, the input/output characteristics of the scan driver, and the like. For example, when the blanking signal input terminal SBLK of the scan driver has a characteristic opposite to the foregoing embodiment, an inversed output is needed. In this case, a NOR gate may be used instead of the OR gate.

FIG. 11 illustrates the connections among a timing controller 400, the scan signal sensor 500, and the scan driver 300 according to an exemplary embodiment of the present invention. Referring to FIG. 11, the scan signal sensor 500, in this case a logic IC, includes a terminal T1 coupled to a terminal SDOUT of the scan driver 300, and a terminal Q coupled to a terminal ENABLE of the power supply 600. Further, a timing controller 400 includes a blank signal output terminal BLK coupled to a blank signal input terminal SBLK of the scan driver 300.

When the scan operation is normal, the output Q of the logic IC has a high level, so that the power supply 600 is normally controlled. On the other hand, when the scan operation is paused, the output Q of the logic IC 500 has a low level, so that the main output of the power supply 600 is cut off, thereby preventing abnormal heat generation or abnormal light emission in the pixel portion 100.

If the power supply is controlled by signals ENABLE, the main power may control only a scan voltage V(scan), or may control the scan voltage V(scan), anode voltage V(anode), and data voltage V(data).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An electron emission display, comprising:
a pixel portion to display a picture based on a data signal and a scan signal;
a data driver to output the data signal to the pixel portion;
a scan driver to output the scan signal to the pixel portion;
a timing controller to output a driving signal to drive the data driver and the scan driver;
a scan signal sensor to control the operation of the scan driver on the basis of the scan signal output from the scan driver; and
a power supply to supply driving power to the pixel portion, the data driver, the scan driver, the timing controller, and the scan signal sensor.

2. The electron emission display of claim 1,
wherein the scan signal sensor senses the scan signal and changes the scan signal from an on signal to an off signal when the scan signal maintains an on signal for a predetermined time.

3. The electron emission display of claim 1,
wherein the scan signal sensor comprises:
an integrated circuit to output a control signal that corresponds to the scan signal, and
an operator to compare and perform a logic operation on outputs of the integrated circuit and the timing controller, and
wherein the operator controls the operation of the scan driver on the basis of the control signal.

4. The electron emission display of claim 3,
wherein the integrated circuit receives the scan signal from the scan driver and outputs the control signal, and
wherein the operator receives and performs a logic operation on the control signal from the integrated circuit and a blanking signal from the timing controller, and outputs an operation signal to a blanking signal input terminal of the scan driver to control the operation of the scan driver.

5. The electron emission display of claim 3,
wherein the control signal has a pulse width corresponding to the pulse width of the scan signal.

6. The electron emission display of claim 1,
wherein the pixel portion comprises:
a bottom substrate;
a stripe-shaped cathode electrode arranged on the bottom substrate;
a first insulating layer arranged on the bottom substrate and the cathode electrode and the first insulating layer having a first hole through which a portion of the cathode electrode is exposed;
a gate electrode arranged on the first insulating layer and the gate electrode intersecting the cathode electrode, and the gate electrode having a second hole corresponding to the first hole;
an emitter formed on the cathode electrode and corresponding to the first and second hole;
a top substrate comprising an anode electrode to receive a high voltage and a fluorescent film to emit light when bombarded with electrons emitted from the emitter; and
a spacer to maintain a distance between the bottom substrate and the top substrate.

7. An electron emission display, comprising:
a pixel portion to display a picture based on a data signal and a scan signal;
a data driver to output the data signal to the pixel portion;
a scan driver to output the scan signal to the pixel portion;
a timing controller to output a driving signal to drive the data driver and the scan driver;
a scan signal sensor to control the operation of the scan driver on the basis of the scan signal output from the scan driver; and
a power supply to supply driving power to the pixel portion, the data driver, the scan driver, the timing controller, and the scan signal sensor and stopping the supply of driving power on the basis of the control signal.

8. The electron emission display of claim 7,
wherein the scan signal sensor senses the scan signal and controls the power supply to stop supplying the driving power when the scan signal maintains an on signal for a predetermined time.

9. The electron emission display of claim 7,
wherein the scan signal sensor comprises an integrated circuit to output a control signal that corresponds to the scan signal, and
wherein the scan signal sensor controls the operation of the power supply on the basis of the control signal.

10. The electron emission display of claim 9,
wherein the power supply cuts off at least one of: the driving power supplied to the pixel portion, the driving power supplied to the data driver, the driving power supplied to the scan driver, and the driving power supplied to the timing controller, on the basis of the control signal.

11. The electron emission display of claim 9,
wherein the control signal has a pulse width corresponding to the pulse width of the scan signal.

12. The electron emission display according claim 7, wherein the pixel portion comprises:
a bottom substrate;
a stripe-shaped cathode electrode arranged on the bottom substrate;
a first insulating layer arranged on the bottom substrate and the cathode electrode and the first insulating layer having a first hole through which a portion of the cathode electrode is exposed;
a gate electrode arranged on the first insulating layer and the gate electrode intersecting the cathode electrode, and the gate electrode having a second hole corresponding to the first hole;
an emitter formed on the cathode electrode and corresponding to the first and second hole;
a top substrate spaced comprising an anode electrode to receive a high voltage and a fluorescent film to emit light when bombarded with electrons from the emitter; and
a spacer to maintain a distance between the bottom substrate and the top substrate.

13. A method of driving an electron emission display, comprising:
generating a control signal corresponding to a scan signal; and
controlling the operation of a scan driver on the basis of the control signal.

14. The method of claim 13,
wherein the control signal has a pulse width corresponding to the pulse width of the scan signal, and
wherein the method further comprises stopping the operation of the scan driver when the pulse width of the control signal is larger than a predetermined period.

15. A method of driving an electron emission display, comprising:
generating a control signal corresponding to a scan signal; and
controlling the operation of a power supply on the basis of the control signal.

16. The method of claim 15,
wherein the power supply generates a plurality of driving powers, and
wherein the method further comprises cutting off at least one of the driving powers on the basis of the control signal.
